(19) United States
(12) Patent Application Publication
(10) Pub. No.: US 2010/0138353 A1
(43) Pub. Date: Jun. 3, 2010

(54) COMPUTER IMPLEMENTED SYSTEM AND METHOD FOR PROVIDING AN OPTIMIZED SUSTAINABLE LAND USE PLAN

(76) Inventors: Avinash Srivastava, Alexandria, VA (US); Steven Kellenberg, Laguna Beach, CA (US)

Correspondence Address: AECOM Technology Corporation, 303 E. Wacker Drive, Suite 600, Chicago, IL, 60601, US

(21) Appl. No.: 12/548,424

(22) Filed: Aug. 27, 2009

Related U.S. Application Data
(60) Provisional application No. 61/092,387, filed on Aug. 27, 2008.

(51) Int. Cl. G06Q 10/00; G06Q 50/00

(52) U.S. Cl. 705/315

(57) ABSTRACT

Briefly, in accordance with one embodiment of the invention, the computer implemented method evaluates the sustainability of land development plan. The computer implemented method applies sustainability data to the land planning and engineering design elements of a land development plan to generate sustainability measures. These sustainability measures may include environmental impacts such as carbon footprints, energy consumption, and increased storm water runoff. In addition, the computer implemented method estimates the costs involved in investing in sustainable land development and construction, provides a cost benefit analysis, compares the sustainability of numerous land development plans, and calculates the near and long term effects of sustainable land development on a land site. This real time analysis will allow developers, municipalities, and residents to quantify land planning decisions without expending significant time and money in a cumbersome land planning process.

### TECHNICAL FIELD AND BACKGROUND OF THE INVENTION

The present novel invention is in the technical field of creating sustainable land planning concepts and designs. More particularly, the invention relates to a computer-implemented method that applies sustainability data to evaluate the sustainability of a land use plan and then generates at least one alternative land use plan that optimizes sustainability measures as selected by the user. The method evaluates the sustainability of a plan by calculating factors that include, but are not limited to, land development costs, environmental impacts, and energy consumption.

Society is presented with significant issues related to environmental degradation, global warming, and energy consumption. Land development and construction can minimize impacts to the environment and reduce the consumption of energy. Land developers, municipalities, home owners, businesses, and many others will benefit from land development that is optimally designed to minimize environmental impacts and reduce energy consumption. Before the present invention, there was no integrated system to evaluate sustainability issues because of the difficulty in compiling voluminous amount of data related to sustainable land development and construction practices, the potential for large scale land development projects, and the difficulty in integrating the voluminous data into a one system process that delivered real-time or instantaneous results. The present invention is useful to persons whose business, decisions, or activities are affected by land development, energy consumption, or environmental impacts.

The present invention was also developed as a result of a need to have a system and method to measure and compare sustainability performance across multiple land sites. Specifically, the present invention provides the following: a framework for defining and measuring sustainability as it applies to land and master planning, a process that can measure sustainability performance for land plan alternatives; a process that incorporates land planning and engineering design elements and spatial configuration in the evaluation; a process that integrates multiple aspects of sustainability such as energy, water, transportation, ecology, socio-cultural and economics into one comprehensive land development plan; a process that considers how these aspects of sustainability interact in a land use plan; a process that measures the cost and benefit of sustainable actions simultaneously; a process that is able to evaluate land development plans with various scales from small sites less than 10 acres to large city scales, and have the flexibility to work with conceptual as well as very detailed data.

The present invention assesses sustainability measures for a land development project. The invention takes a comprehensive view of sustainability as it relates to a land development or improvement project by addressing a range of relevant themes, including, but not limited to, as-built environments, ecology & ecosystem services, socio-economics, transportation and water systems. The method integrates dependent and independent models that provide data related to the above themes, whereby those models interact to provide information allowing the user to optimize the sustainable design characteristics of a land development plan. The invention provides a cost-benefit analysis of the land development plan to provide the user information related to the impact certain sustainable design characteristics may have on the cost of the land development plan. The user may then adjust the sustainable design characteristics to generate a plan that minimizes the economic impact of a sustainable land development plan. The invention selects and evaluates various groups of data input to determine how such groups of data perform in improving or not improving sustainability benchmarks. The invention creates concepts and designs that are a combination of various groups of data input and compare alternative concepts and designs.

### SUMMARY OF THE INVENTION

It is an object of the invention to provide a computer implemented method to evaluate the sustainability of at least one land development plan for a land site.

It is another object of the invention to generate at least one alternative sustainable land development plan for a land site based on user selected land planning and engineering design elements.

It is another object of the invention to provide a computer implemented method that accesses sustainability data specific to the circumstances of a particular land use or development plan.

It is another object of the invention to establish a baseline plan in which alternative plans are compared.

It is another object of the invention to compare the sustainability measures of a baseline plan to the alternative land plans. This invention compares all sustainability measures.

It is another object of the invention to compare the costs to construct, cost benefit analysis, environmental impacts, energy consumption, and carbon footprints of the baseline plan to the alternative land plans.

It is another object of the invention to generate a cost benefit analysis (CBA) for a sustainable land development plan. The CBA identifies sustainability measures that are more cost-effective and allocate the costs to the appropriate land development parties such as, but not limited to, the developer, builder, home owner, municipality, or other third parties. The CBA can include, depending on certain thresholds established by the various parties such as, but not limited to, capital cost limits, willingness-to-pay limits, repayment of the investment, and return on investment. The CBA can include an analysis of mortgage amortization, rental premiums, repayment of the investment, return on investment, life-cycle costs.

It is another object of the invention to provide a computer-implemented method takes a whole systems modeling (WSM) view and includes a framework to integrate a plurality of thematic performance models (TPM). A TPM includes a plurality of internal dependent and independent processes and calculations that provide the WSM with data input based on a theme, such as, but not limited to, non-residential building energy, residential building energy, domestic water, public realm energy, transportation, distributed energy, urban heat island, smart grid technology, and ecology. In addition to the internal dependent and independent processes, a TPM may be dependent on the WSM and other TPMs.

It is another object of the invention to provide a computer-implemented method that incorporates secondary and tertiary effects of actions by using interaction modeling techniques that accommodates empirical relationships.

It is another object of the invention to generate illustrations and documentation that communicate the results of the sustainability evaluation of a land plan for a land site.

It is another object of the invention to generate illustrations and documentation that communicate the results of the sustainability evaluation of alternative land plans for a land site.

It is another object of the invention to provide a computer-implemented method that provides interactive gaming to develop alternative scenarios related to the sustainability of a land development plan.

It is another object of the invention to generate cost estimates of the construction of the selected land planning and engineering design elements.

It is another object of the invention to use a user interface that can be any one of a plurality of interfaces used by a plurality of computer applications. The interface is an interactive user friendly interface that provides a variety of tables, charts, dials and menus to present analysis results, and allow interactive gaming of sustainability options. This user interface is sometimes herein referred to interactive dashboards.

It is another object of the invention to provide the computer implemented method remotely to a user with a second computer communicating with a host server that is communicating to said first computer over a network such as the internet. In other embodiments, other computer networks, for example, a wide are network (WAN), local area network (LAN), or intranet may be used.

These and other objects of the present invention are achieved in the preferred embodiments discussed below by providing a computer implemented method to calculate the sustainability of at least one land development plan for a land site and to generate at least one optimal sustainable land development plan. The system employs a computer readable medium and a computer program encoded medium. The computer program is operable, when executed on a computer, for electronically evaluating a plurality of land development sustainability measures on at least one land development plan.

The term “sustainable” or “sustainability” is defined broadly herein to refer to any means that preserves or reduces impact to the environment or any ecosystem. The term “sustainability measures” refers to any value or data that may alter the impact to the environment or ecosystem. Examples of sustainability measures are listed in Table 1 below. The term “land development” is defined broadly herein to refer to the alteration of a land site from its present condition.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following description when read with the accompanying drawings in which:

FIG. 1 is a schematic illustration of the present invention according to one preferred embodiment;

FIG. 2 is a flowchart of the present method and system according to one preferred embodiment of the invention;

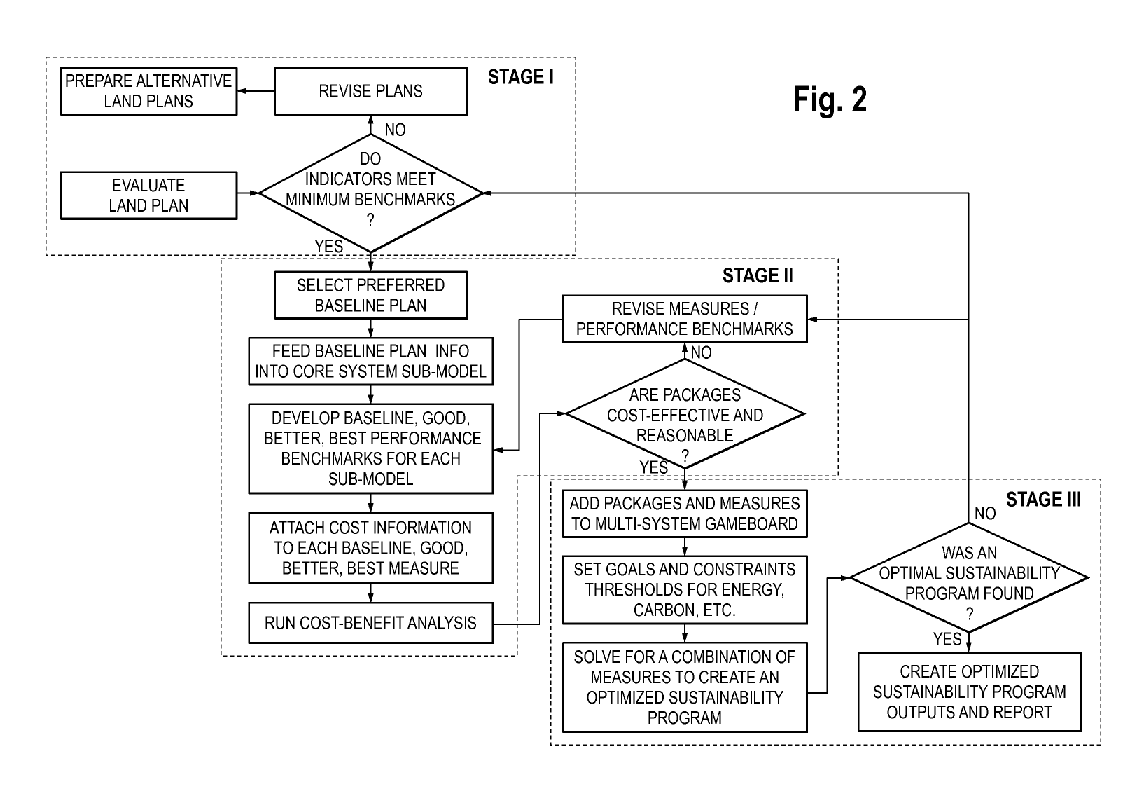

FIG. 3 is a computer generated output example showing carbon emission reductions per $1000 invested (Initial Cost);

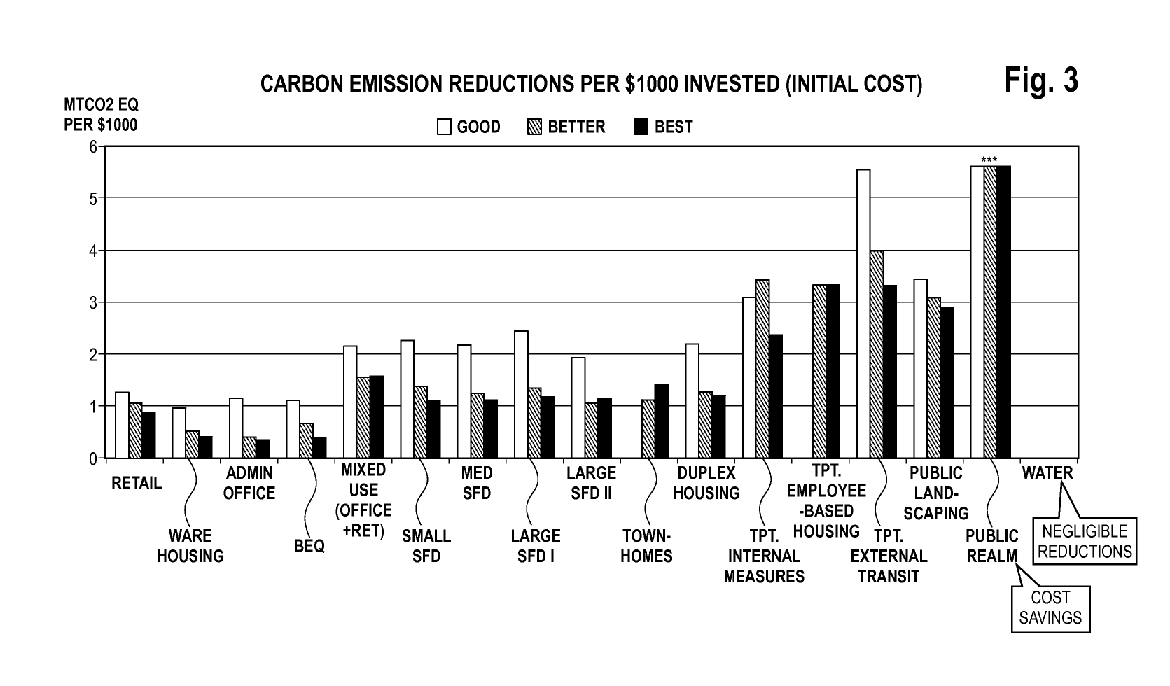

FIG. 4 is a computer generated output example showing a life cycle cost anaylsis;

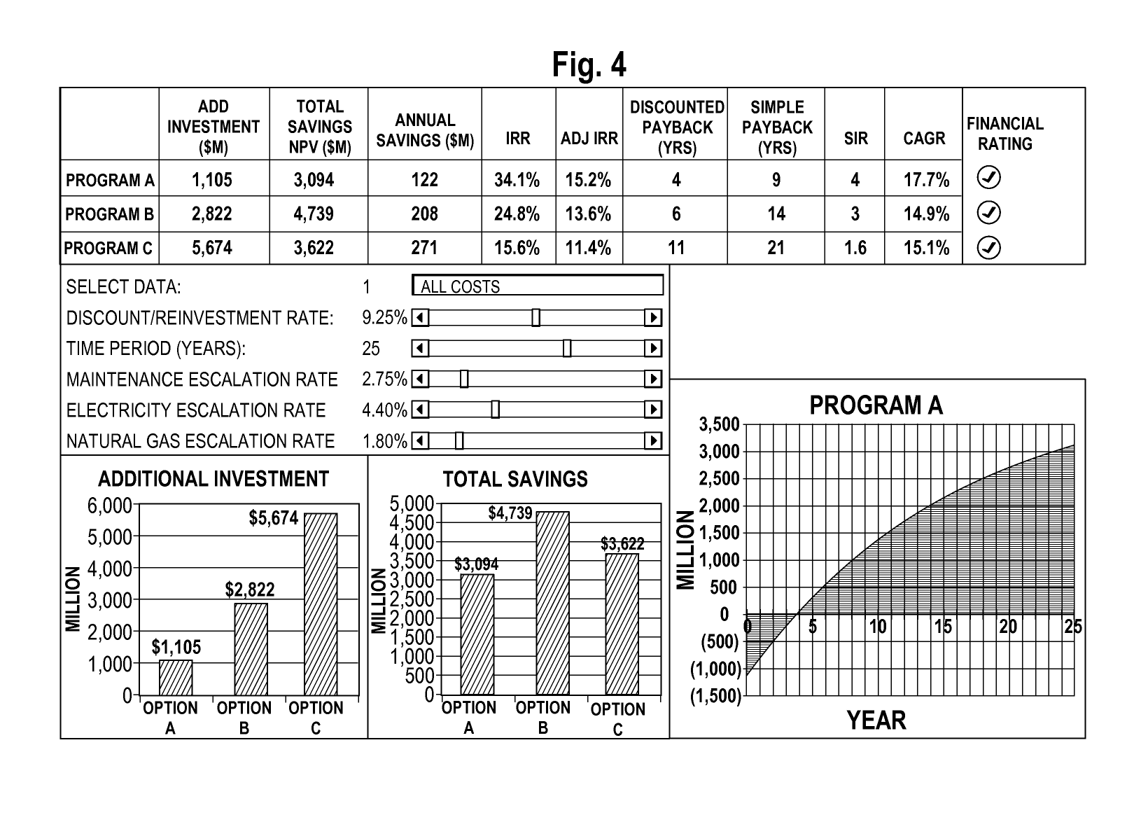

FIG. 5 is a computer generated user interface example showing a run optimization routine used to optimize the sustainability of a land development plan;

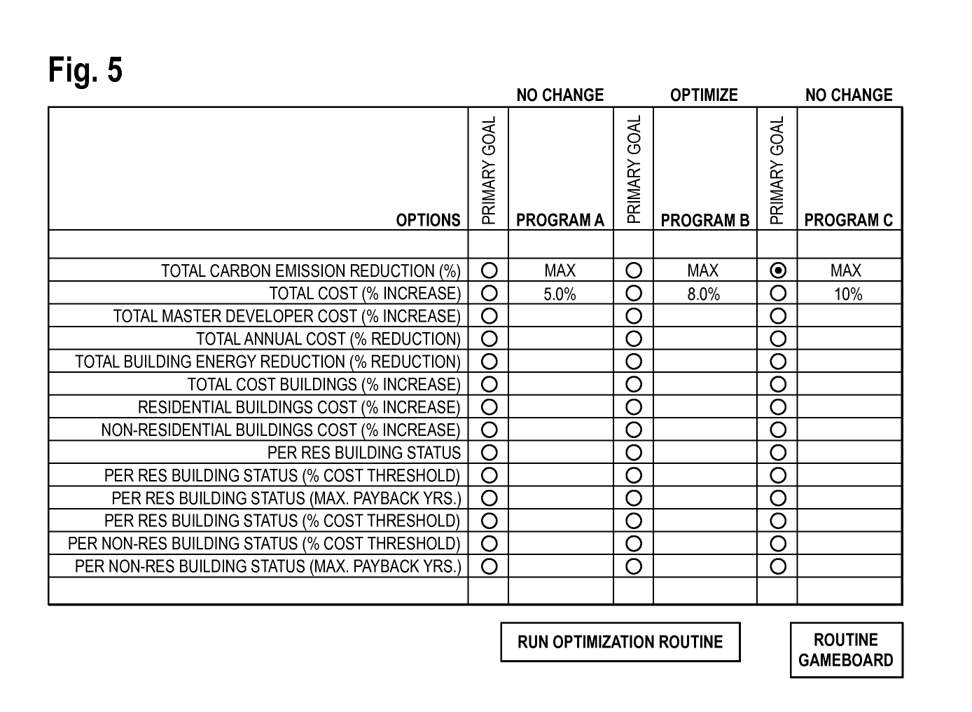

FIG. 6 is a computer generated output example showing a stage III program selection gameboard;

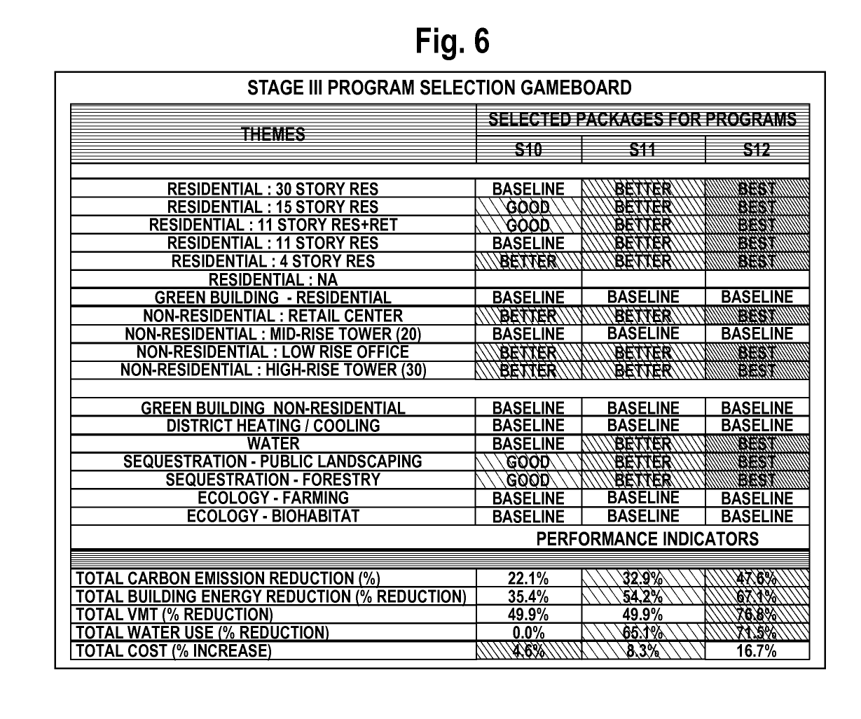

FIG. 7 is a computer generated output example showing a program performance spectrum;

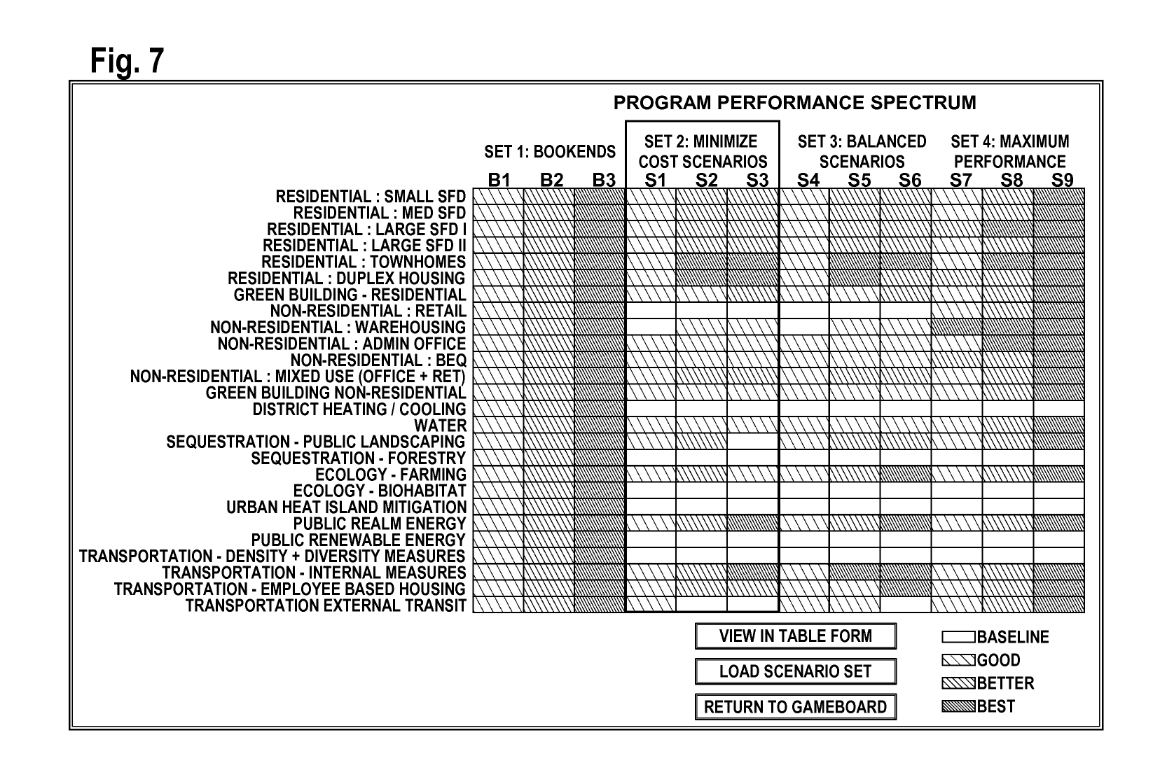

FIG. 8 is a computer generated output chart example showing a program performance comparison;

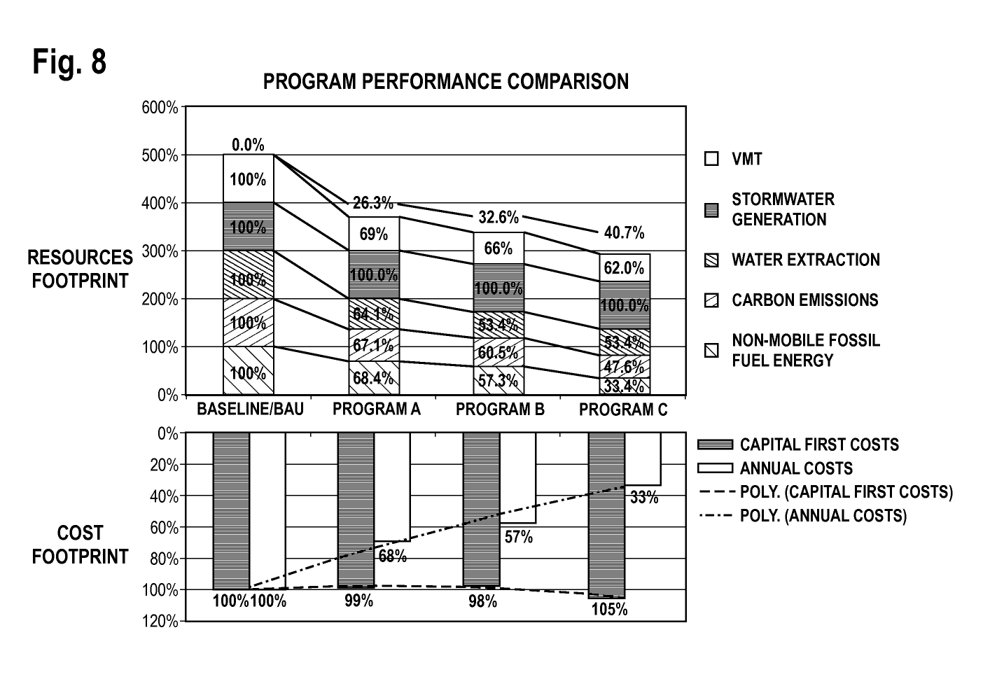

FIG. 9 is a computer generated output chart example showing the total carbon emission generated by a plurality of land development plans;

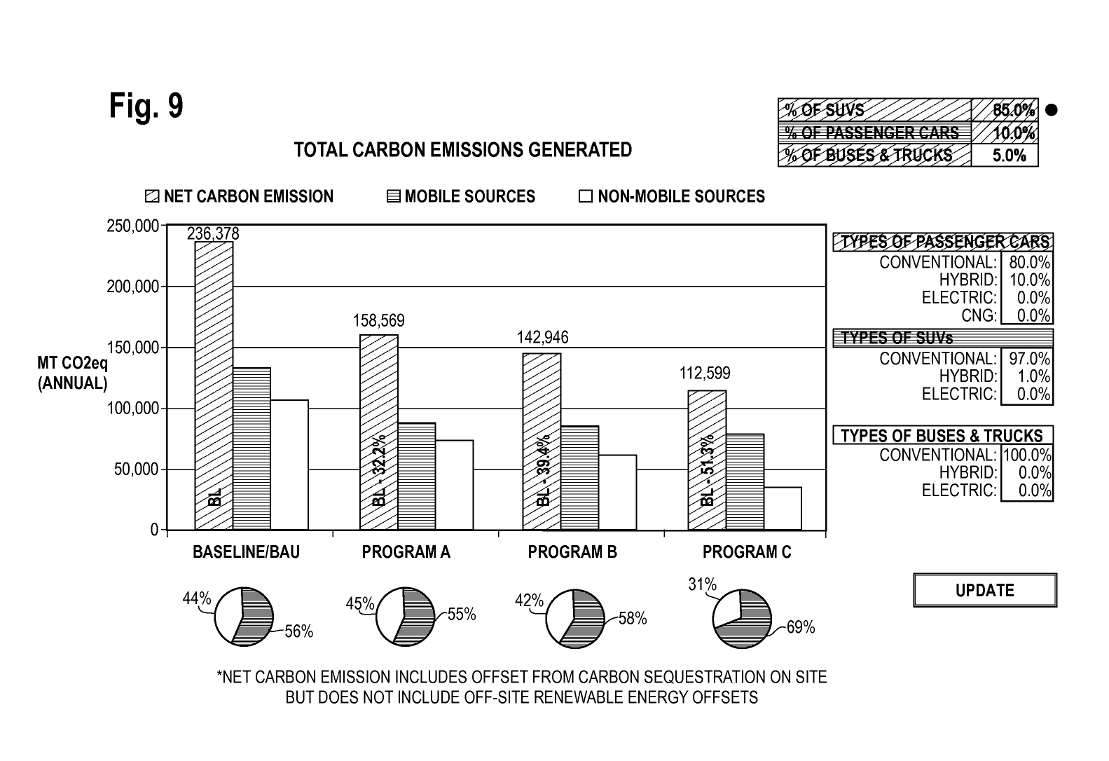

FIG. 10 is a computer generated output table example showing environmental results from a plurality of land development plans.

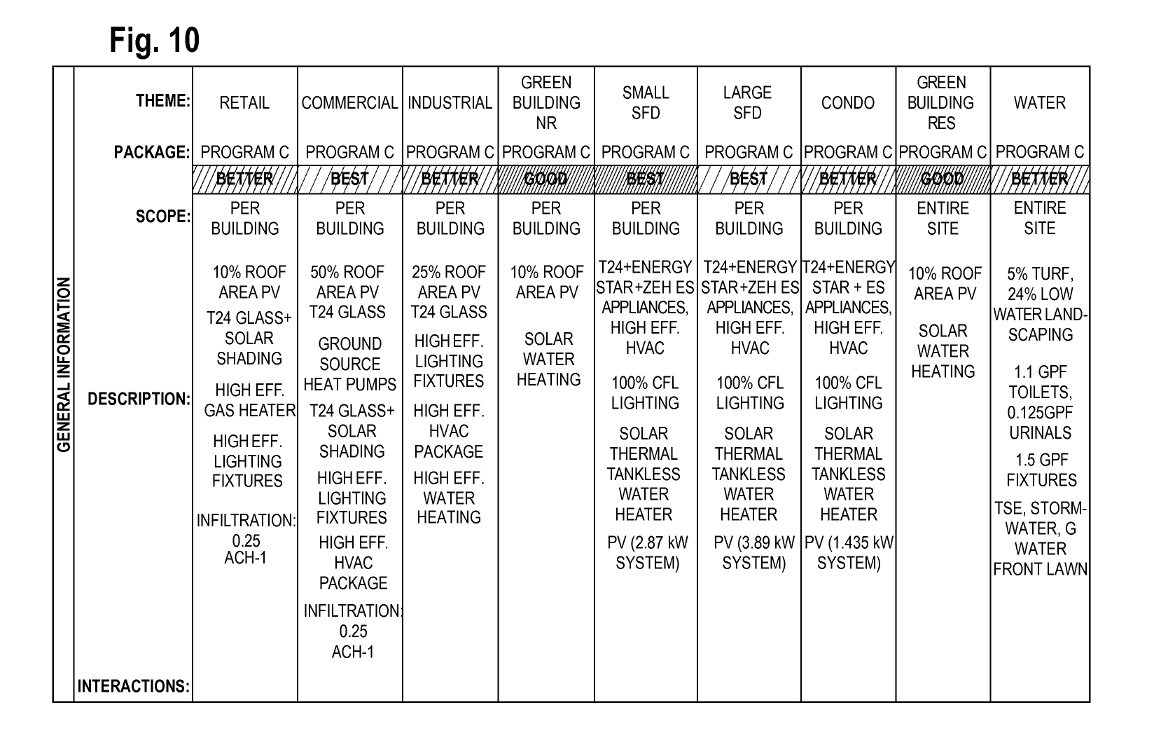

### DETAILED DESCRIPTION OF THE PREFERRED EMBODIMENT AND BEST MODE

Some portions of the detailed descriptions that follow are presented in terms of algorithms and symbolic representations of operations on data bits within a computer memory. These algorithmic descriptions and representations are the means used by those skilled in the arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “evaluating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Algorithms and displays presented herein are not inherently related to any particular computer or other apparatus. Various general-purpose machines may be used with programs in accordance with the teachings herein, or it may prove convenient to construct more specialized apparatus to perform the required method steps. The required structure for a variety of these machines will appear from the description below. In addition, the present invention is not described with reference to any particular programming language. It will be appreciated that a variety of programming languages may be used to implement the teachings of the invention as described herein.

While the detailed description that follows enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the embodiment, method, and examples in the following detailed description, but by all embodiments and methods within the scope and spirit of the invention as claimed.

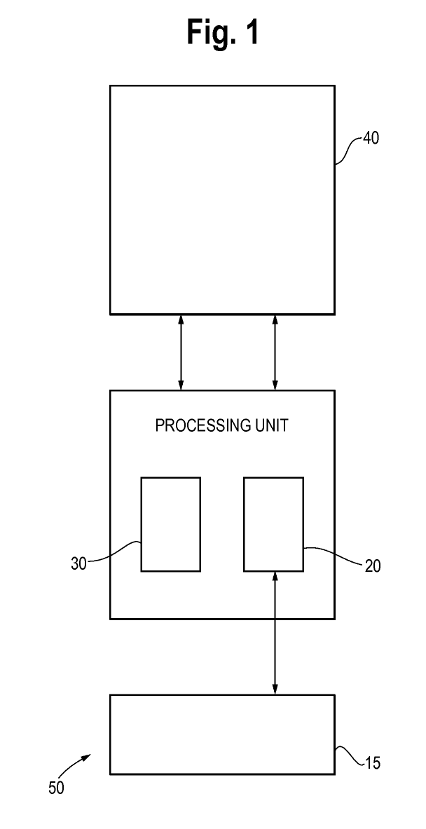

The present invention is represented broadly in the schematic design of FIG. 1. In one preferred embodiment, computing device 50 includes a processing unit 10 for executing the problem solving method 20, a memory 30 to store the problem solving method, an input/output (I/O) device 40 connecting to the processing unit 10. Data storage 15 is connected to processing unit 10.

The problem solving method 20, discussed further below, utilizes, as input, sustainability data from data storage 15. The problem solving method 20, may output a land development plan or sustainability data from a land development plan to data storage 15. In other embodiments, the data storage 15 may comprise an electronic file, disc or other data storage device. The data storage device 15 may store other items useful to carry out the function.

The I/O device 40 may comprise a monitor, printer or other output device that displays a land development plan, sustainability data, output or other data generated by problem solving method 20. The I/O device 40 may comprise of a keyboard, mouse or other input device that may input date by a user and used by problem solving method 20.

In one example, the problem solving method 20 comprise a plurality of algorithms to evaluate and develop a comprehensive sustainability plan for a land development or land improvement project. In the present example, the problem solving method 20 uses a three stage process as further described below:

### Stage I

Stage I, (sometimes referred to herein as “Urban Framework and Base Case”,) is a process in which at least one land plan, but may include a plurality of land plans, is evaluated for sustainability using a plurality of sustainability measures such as, those listed in Table 1.

TABLE 1
SUSTAINABILITY MEASURES

| | |
|---|---|
| 1 | Roof Area PV |
| 2 | T24 Glass + Solar Shading |
| 3 | High Efficiency Lighting Fixtures |
| 4 | High Efficiency Gas Heater |
| 5 | High Efficiency Water Heating |
| 6 | Ground Source Heat Pumps |
| 7 | High Efficiency HVAC Package |
| 8 | Insulation |
| 9 | Appliances |
| 10 | Construction Waste Management & Diversion |
| 11 | Recycled Material Use |
| 12 | Certified Wood & Local Materials |
| 13 | Low VOC Paints |
| 14 | Indoor Air Quality Controls & Measures |
| 15 | Turf & Low Water Landscaping |
| 16 | Low gpf Toilets |
| 17 | Low gpf fixtures |
| 18 | Green Roofs |
| 19 | Treated Sewage Effluent (TSE) |
| 20 | Stormwater Management & LID |
| 21 | Cisterns and Rain Gardens |
| 22 | Grey Water Use |
| 23 | Street light spacing & Operations |
| 24 | High Efficiency Technology - LED etc. |
| 25 | High Efficiency Traffic Signals |
| 26 | Parking Lot Lighting Demand Management |
| 27 | Landscape Lighting Management |
| 28 | Dark Sky Measures |
| 29 | Biomass Energy |
| 30 | PV |
| 31 | Wind Turbines |
| 32 | GeoThermal |
| 33 | Bio-Gas |
| 34 | CHP |
| 35 | Distributed Efficiency |
| 36 | Advanced Control Systems |
| 37 | 4D Measures |
| 38 | travel services centers |
| 39 | internal shuttle service |
| 40 | sheltered shuttle stops |
| 41 | shared parking |
| 42 | EV charge stations |
| 43 | shared electric vehicles |
| 44 | community bikes, bike lockers |
| 45 | bike/walk trail net |
| 46 | traffic calming |
| 47 | Employee Housing Measures |
| 48 | External Rail/Transit Linkages |
| 49 | External Shuttles to Nearest Transit Station |
| 50 | Transportation Coordinator |
| 51 | Microclimate Engineering |
| 52 | Community Treescape |
| 53 | Water Features for Cooling |
| 54 | Highly Reflective Materials |
| 55 | Public Landscaping |
| 56 | Community Farming |
| 57 | Carbon Sequestration (Forestry) |
| 58 | Bio-Diversity Enhancement |
| 59 | Urban Heat Island Mitigation |
| 60 | Integrating Habitats |
| 61 | Sustainable Urban Drainage |
| 62 | Site-Climate Design |
| 63 | Bio-Mimicry |
| 64 | Recreation and Education |
| 65 | Wetland Restoration |

In Stage I the method determines a preferred land plan based on a user's specified desired sustainability measures. This preferred land plan is further analyzed by Stages II and III. The present invention is built around a framework that integrates, a series of thematic performance and process models, a core integration model and finally a series of databases that are linked to the various models.

Some sustainability measures are based on spatial configuration. Stage I may use a geographic information systems (GIS) analysis to evaluate those sustainability measures that are based on spatial configuration. For example, a GIS-based tool may be used to analyze the land plan and tabulate spatial metrics that impact sustainability measures such as the area of impervious ground cover or the distance between public transportation linkages. These metrics are then provided to a spreadsheet or database. An algorithm uses prototypical landuse, building densities and typologies and the GIS information extracted from the land plan to calculate sustainability measures.

### Stage II

Stage II, (sometimes referred to herein as “Core Theme Optimization”) is a process in which each TPM is calibrated with values of sustainability measures that are reasonable or typical to the location of the land plan. The calibrated TPM is referred to as the “Baseline”. The user then creates up to three additional land development plans by selecting and applying improved sustainability measures on the “Baseline”. These three additional land development plans are classified as “Good”, “Better” or “Best”. The Good, Better, Best ratings are based on a relative improvement in the sustainability measures, selected by the user, over the Baseline. The term “benchmark” as used herein refers to the sustainability measures of the Baseline, Good, Better, and Best land development plans. The improvement is based on user defined criterion such as improved energy savings and carbon reduction. The present example uses TPMs such as those listed in Table 2.

TABLE 2
Thematic Performance Models

| | |
|---|---|
| 1 | Building Energy |
| 2 | Green Building |
| 3 | Domestic Water |
| 4 | Public Realm Energy |
| 5 | Distributed Energy |
| 6 | Smart Grid Technology |
| 7 | Transportation |
| 8 | Urban Heat Island |
| 9 | Ecology & Ecosystem Services |

The present example has been created in a spreadsheet application. The present example uses macros and code to supplement existing spreadsheet functionality. The spreadsheet application comprise of some TPMs and the respective TPM data tables. However, the spreadsheet application comprise of some TPMs accessed from an external application such as a database. In the present example, the TPMs are all based on a spreadsheet application and can be accessed by the WSM.

The computer-implemented method may be built or developed on a plurality of applications. The present example comprises of the following main components:

Community Simulation Component. This component is responsible for scaling building level performance to community level, combining various theme performances to overall performance and calculating overall program results.

Cost plus Cost Benefit plus Cost Allocation Component. This component calculates aggregate costs, life-cycle costs and cost-benefit ratios, cost allocations to agents etc. It uses cost data collected for the project, and cost factors used by each TPM.

Interactions Post-Processor Component. This component handles interactions between various TPMs. Each interaction is defined as a change-value to a particular factor or indicator used by a TPM. The interactions post-processor compiles all change values and computes the net values that are used by the Community Simulation component.

Integration Component. This component handles data exchange and populates tables from TPMs.

Dashboard and Interface Component. This component handles and defines all menus, buttons, sliders, and hyperlinks used within the model.

Outputs Component. This component handles all graphical and tabular displays as well as text labels and graphics that are automatically generated. Table 3 is an example of the type of graph that is generated. The outputs component also handles the creation of electronic presentations with appropriate scenario information and graphics.

TABLE 3

| | | | Scheme 1 | Scheme 2 | Scheme 3 |
|---|---|---|---|---|---|
| Homes | Residents | Persons | 108,473 | 104,549 | 155,654 |
| | Dwellings | DU | 36,158 | 34,850 | 51,885 |
| | Population Density | Persons/Ha | 104.8 | 113.5 | 155.2 |
| | Gross Housing | DU/Ha | 34.9 | 37.7 | 51.7 |
| | Density | | | | |
| | Net Housing | DU/Ha | 144.8 | 176.0 | 200.8 |
| | Density | | | | |
| Jobs | Job | Employees | 15,172 | 7,865 | 7,074 |
| | Jobs to Housing | Ratio | 0.4 | 0.2 | 0.1 |
| | Ratio | | | | |
| | % of Jobs Walkable | Percent | 56.0% | 74.0% | 76.0% |
| | from Transit | | | | |
| Ecology | $ of Parkland & | Percent | 11.7% | 14.0% | 32.0% |
| | Open Space | | | | |
| | Parks per 1000 | Ha per 1000 | 1.1 | 1.3 | 2.1 |
| | Population | Person | | | |
| | Open Space | Index | 61.0 | 65.0 | 78.0 |
| | Connectivity Index | | | | |
| | % of Ecological | Percent | 51.5% | 60.3% | 77.2% |
| | Land Preserved | | | | |
| | % Land with | Percent | 36.0 | 34.5% | 30.0% |
| | Impervious Surfaces | | | | |
| Resource | Energy Use per | KWHr per | 21,798 | 21,249 | 21,080 |
| Inputs | Person | Capita per Year | | | |
| | Water Use per | Liters per | 341 | 315 | 301 |
| | Person | Capita per Day | | | |
| | Gasoline | Liters per | 0.43 | 0.45 | 0.36 |
| | Consumption per | Capita per Day | | | |
| | Person | | | | |
| | Vehicle Kilometers | VKT per | 49.3 | 42.2 | 41.3 |
| | per Person | Person per Day | | | |
| Waste | Carbon Emissions | MT per Person | 19 | 18 | 17 |
| Ouptuts | per Person | per Year | | | |
| | Storm-water Runoff | Cubic Meters | 2,549 | 2,466 | 2,327 |
| | | per Year | | | |
| | Solid Waste | MT per Year | 43,000 | 42,000 | 63,000 |
| | Generated | | | | |
| Finance | Reference Cost per | $/Person | 91,097 | 78,815 | 77,816 |
| | Capita | | | | |
| | Reference Cost per | $Ha | 10,616,832 | 11,647,441 | 11,812,186 |
| | Ha | | | | |

### Stage III

Stage III is a process in which the user defines an optimal sustainability program by selecting package options for the Baseline, Good, Better, or Best land development plans identified in Stage II. In the present example, the process performs a CBA on the selected land development plans. If the user determines that the selected land development plan or plans are cost effective over a specified period of time, then the process will allow the user to select optimization goals for the selected land development plan or plans. If the selected land development plan or plans are not cost effective, the user must revert to Stage II to revise the user-defined benchmarks.

After identifying a cost effective land development plan or plans, the user next selects sustainability goals and constraints to optimize one or more sustainability measures. The present example provides the user with a gaming option that allows the user to alter sustainability measures on one or more of the Baseline, Good, Better, and Best land development plans. When the user alters any of the plurality of sustainability measures on one or more of the land development plans, the computer implemented system evaluates and generates real-time environmental and cost impact estimations. Examples of gaming options include: selecting carbon output changes due to an increase of hybrids or electric vehicles used by a vehicle fleet operating within the land development plan; changing renewable energy options to see implications on land, energy and cost. In addition to providing real-time result

The present example comprises a user interface (sometimes referred to herein as a “Dashboard”) that allows users to change options and view environmental impacts and CBAs in real-time. The method also facilitates saving scenarios and, if a user so decides, creating electronic based presentations that present such scenarios.

We claim:

1. A computer implemented method to calculate the sustainability of at least one land development plan for a land site and to generate at least one optimal sustainable land development plan, said method comprising:
means for accessing a plurality of sustainability data for a plurality of land development sustainability measures;
means for quantitatively evaluating a plurality of land development sustainability measures on at least one land development plan based on said sustainability data;
means for altering the land development plan to optimize the sustainability of said land development plan;
means for outputting to a user documentation displaying said plurality of land development sustainability measures.

2. A computer implemented method according to claim 1, and comprising means for quantitatively evaluating the spatial configuration of said land site and applying the spatial configuration of said land site to sustainability measures dependent on the spatial configuration of said land site.

3. A computer implemented method according to claim 2, and comprising means for comparing a plurality of sustainability measures of more than one land development plan for said land site to identify a user-defined optimal sustainable land development plan;

4. A computer implemented method according to claim 3, and comprising means for optimally selecting a set of user-defined sustainability measures to generate alternative sustainable land development plans.

5. A computer implemented method according to claim 3, and comprising means for optimally selecting a set of predefined sustainability measures to generate alternative sustainable land development plans.

6. A computer implemented method according to claim 3, and comprising means for generating costs associated with the sustainability measures used on a land development plan;

7. A computer implemented method according to claim 6, and comprising means for selecting a set of user-defined sustainability measures based on the costs associated with said sustainability measures.
